(19) United States
(12) Patent Application Publication
(10) Pub. No.: US 2001/0039535 A1
(43) Pub. Date: Nov. 8, 2001

(54) Methods and systems for making secure electronic payments

(76) Inventors: Yiannis S. Tsiounis, New York, NY (US); Charles Doherty, Freeport, NY (US)

Correspondence Address: Finnegan, Henderson, Farabow,, Garrett & Dunner, L.L.P., 1300 I Street, N.W., Washington, DC, 20005, US

(21) Appl. No.: 09/780,031

(22) Filed: Feb. 9, 2001

Related U.S. Application Data
(60) Provisional application No. 60/181,224, filed on Feb. 9, 2000.
(60) Provisional application No. 60/181,225, filed on Feb. 9, 2000.

(51) Int. Cl. G06F 17/60; H04K 1/00

(52) U.S. Cl. 705/71; 705/77; 705/78; 705/72

(57) ABSTRACT

The present invention provides methods and systems for securing payment over a network from a customer to a merchant. A trusted party component receives an instruction from the customer to pay the merchant, the instruction including confidential payment information of the customer. The trusted party component creates payment authentication information based on the confidential payment information. Based on the payment authentication information, the trusted party component pays the merchant on behalf of the customer without the confidential payment information of the customer being disclosed to the merchant.

### RELATED APPLICATION DATA

The present application is related to and claims the benefit of U.S. Provisional Application No. 60/181,224, filed on Feb. 9, 2000, entitled “System for Secure and Efficient Internet-based Payments Linked to Checking Account,” and U.S. Provisional Application No. 60/181,225, filed on Feb. 9, 2000, entitled “Method and System for Making Anonymous Electronic Payments on the World Wide Web,” both of which are expressly incorporated in their entirety herein by reference.

### BACKGROUND OF THE INVENTION

1. Field of the Invention

The present invention is generally related to electronic commerce and, more particularly, to methods and systems for making secure electronic payments on insecure networks, such as, for example, the Internet.

2. Background

The World Wide Web (“Web”) has evolved into a new commercial environment with enormous potential. Fueled by its universal appeal, instant and worldwide access, ease of use and low cost of operation, the Web has been the location of choice for a surprising number of merchants, vendors and service providers alike.

To realize the full commercial power of the Web, however, it is important to provide efficient payment mechanisms. With a payment-processing infrastructure in place, customer transactions can be completely performed online without requiring in-person or vocal communication. So-called “click-and-pay” methods translate to more efficient payment processing and reduced operational costs for merchants.

In conventional payment transactions, customers wishing to purchase goods or services are at some point required to give confidential payment information to the merchant offering the goods or services. Customers, for example, are required to provide a name, address, and confidential payment information specific to the customer, such as a debit card number, credit card number, or bank account number and routing information. Many people understandably feel uncomfortable using credit cards on-line, and are extremely cautious when giving account information over the Internet. This caution is justifiable because, with this information, an interloper has all the information necessary to make unauthorized transactions.

Merchants doing business over insecure networks attempt to secure customer confidential payment information by securing the line of transmission using a secure transmission protocol, such as Secure Sockets Layer (“SSL”). SSL is a transport level technology for authentication and data encryption between a Web server and a Web browser. SSL, and other secure transmission protocols, however, secure the information only during transmission and not at a merchant's site. The customer's confidential payment information remains vulnerable to break-in attacks on computer equipment and databases at the merchant's end. Furthermore, under conventional methods, customers are not protected from impersonation attacks, also called “man-in-the-middle” attacks, where an identity thief impersonates a vendor and the customer, believing he is dealing with a reliable merchant, transmits confidential payment information to the impersonator, who then uses the confidential payment information to make unauthorized transactions. The lack of methods for combating these types of security attacks has contributed to an increased credit card theft over the Internet and increased transaction costs of legitimate merchants.

There have been some efforts to improve the security of payment transactions over an insecure network. The SET Secure Electronics Transaction™ specification, for example, is an open technical standard developed by Visa and MasterCard, to facilitate secure payment card transactions over the Internet. The SET specification uses digital certificates to verify the identities of both a merchant and a cardholder. The SET specification, however, has proven difficult and costly to implement since it requires the installation of specialized software by all parties involved—card-issuing banks, credit card processors, participating merchants, and customers. Furthermore, deploying SET requires a large investment of time and money to distribute, manage, verify and educate participants on the proper use of the digital certificates.

Thus, it is preferable to design a system which can be used by any client machine, be installed at any merchant, and be run from any bank, without special hardware or software requirements.

In summary, the e-commerce community still lacks a simple and easy-to-use “click-and-pay” method and system of making electronic payments which promotes a spur-of-the-moment paying habit and which affords anonymity, security and accountability. Furthermore, any conventional solutions require that all parties to a transaction undergo changes to hardware or install specialized software and do not often work across all computer platforms.

### SUMMARY OF THE INVENTION

The present invention provides methods and systems for securing payment over a network from a customer to a merchant. A trusted party component receives an instruction from the customer to pay the merchant, the instruction including confidential payment information of the customer. The trusted party component creates payment authentication information based on the confidential payment information. Based on the payment authentication information, the trusted party component pays the merchant on behalf of the customer with the confidential payment information of the customer being disclosed to the merchant.

### BRIEF DESCRIPTION OF THE DRAWINGS

The accompanying drawings provide a further understanding of the invention and are incorporated in and constitute a part of this specification. The drawings illustrate various embodiments of the invention, and, together with the description, serve to explain the principles of the invention.

FIG. 1 illustrates one embodiment of a method for making electronic payments consistent with the present invention;

FIG. 2 shows an exemplary procedure performed by the PAN calculator.

FIG. 3 illustrates another embodiment of a method for making electronic payments over an insecure network consistent with the present invention;

FIG. 4 illustrates the functions performed by PT Server 140;

FIG. 5 illustrates yet another embodiment of a method for making electronic payments consistent with the present invention;

FIG. 6 illustrates yet another embodiment of a method for making electronic payments consistent with the present invention;

FIG. 7 illustrates a system consistent with the present invention;

FIG. 8 depicts a more detailed diagram of the customer computer depicted in FIG. 7; and

FIG. 9 depicts a more detailed diagram of the PAN server depicted in FIG. 7.

### DETAILED DESCRIPTION

The following detailed description of the invention refers to the accompanying drawings. Although the description includes exemplary implementations, other implementations are possible and changes may be made to the implementations described without departing from the spirit and scope of the invention. The following detailed description does not limit the invention. Instead, the scope of the invention is defined by the appended claims. Wherever possible, the same reference numbers will be used throughout the drawings and the following description to refer to the same or like parts.

The present invention provides methods and systems for making secure electronic payments over the Internet. In accordance with the principles of the present invention, when a user instructs payment to a merchant, a user's confidential payment information, is not available to the merchant. Confidential payment information includes all information unique to the customer that is necessary for completing an electronic payment transaction. Confidential payment information may include, but is not limited to, such information as, prepaid debit card number, bank debit card number, credit card number, expiration date and/or personal identification number (“PIN”), bank account number and routing information, check number, Beenz number used for Beenz Internet payments, Flooz number used for Flooz Internet payments and digital signature. In methods and systems consistent with the present invention, confidential payment information is provided to a trusted third party and the trusted third party facilitates the merchant receiving the payment without the merchant having access to the user's confidential account information.

The Web is the universe of information available to users over the world-wide network called the Internet. The Web is accessed through a body of software, a set of protocols, and a set of defined conventions for getting at the information on the Web. Web browsers, such as MOSAIC®, NETSCAPE® or INTERNET EXPLORER®, are software operating on a user's computer, referred to as a “client,” that allows users to move easily from one Web site to another. To “surf” the Web, a user makes an Internet connection and launches a Web browser. The Web browser contacts a Web site on a server over the Internet and requests information or resources. The server locates the information and then sends the information to the Web browser, which displays the results on the client computer. Web browsers use the HyperText Transfer Protocol (“HTTP”) to communicate between a client computer and a server over the Internet.

When users surf the Web, they view multimedia web pages composed of text, graphics and multimedia content, such as sound and video, in a browser. The user may enter a Universal Resource Locator (“URL”) in the browser specifying a location (server) to visit. The user may also “click” on a link to forward the user to a new location. When a server finds the requested web page, document, or object, the server sends the information back to the Web browser.

A Web browser displays information by interpreting the Hypertext Markup Language (“HTML”) used to build web pages. The coding in an HTML files tells the browser how to display the text, graphics, links and multimedia files on a web page. The HTML file that the browser receives from the server does not have graphics, sound, multimedia files and other resources on it. Instead, the HTML file contains HTML references to those graphics and files. The browser may use the references in the HTML file to find the files on servers, and display as a home page in the browser.

Web browsers typically runs application programs that are written in JAVA®, a computer language developed by SUN MICROSYSTEMS®. JAVA® is an object-oriented programming language that allows programmers to create interactive programs and add multimedia features to home pages. NETSCAPE is an example of a Web browser capable of running JAVA® programs. JAVA® programs that run at the client inside a browser are called “applets.

When a user visits a Web site or server that contains JAVA® applets, the applets maybe downloaded to the user's computer from the server. Once an applet is downloaded, it runs automatically.

The nature of the Internet is that it is an insecure network. As packets travel across the Internet, any user could conceivably examine the packets. Because of the Internet's insecure nature, there are potential dangers to doing business online. If a user provides confidential account information on the Internet, a third party could steal the account information and other identifying information. Software engineers have developed schemes to transmit confidential information securely to combat this problem. This is known as encryption and decryption.

Information to be sent needs to be encrypted, that is, altered so that to third parties the information will look like meaningless garble. The information also needs to be decrypted, that is, turned back into the original message by the recipient, and only by the recipient. Many complex systems known as “cryptosystems,” have been created to allow for this kind of encryption and decryption.

The heart of understanding how cryptosystems work is to understand the concept of “keys.” Keys are secret values used by computers in concert with complex mathematical formulas to encrypt and decrypt messages. For example, if a user encrypts a message with a key, only a user with a matching key could decrypt the message. There are two kinds of common encryption systems: secret-key cryptography, also called symmetric cryptography, and public-key cryptography, also called asymmetric cryptography.

In secret-key cryptography, only one key is used to encrypt and decrypt messages. Both the sender and receiver need copies of the same secret key. In contrast, public-key cryptography uses two keys (a public key and a private key). Each user (sender and recipient) has both a public key and a private key. The public key is made freely available, while the private key is kept secret on the user's computer. The public key can encrypt messages but only the private key can decrypt messages that the public key has encrypted. If a sender wants to send a message to a recipient, for example, the sender may encrypt the message with the recipient's public key. But only the recipient, with the private key, could decrypt and read the message. The public key could not decrypt the message. An example of public/private-key cryptography is the well-known Pretty Good Privacy (“PGP”) encryption system.

In methods and systems consistent with the present invention, a Trusted Third Party (“TTP”) guarantees the security of payment transactions without requiring many of the involved parties, such as the banking institutions, transaction processors, and the customers, to make even minimal, if any, changes to their current modes of operation.

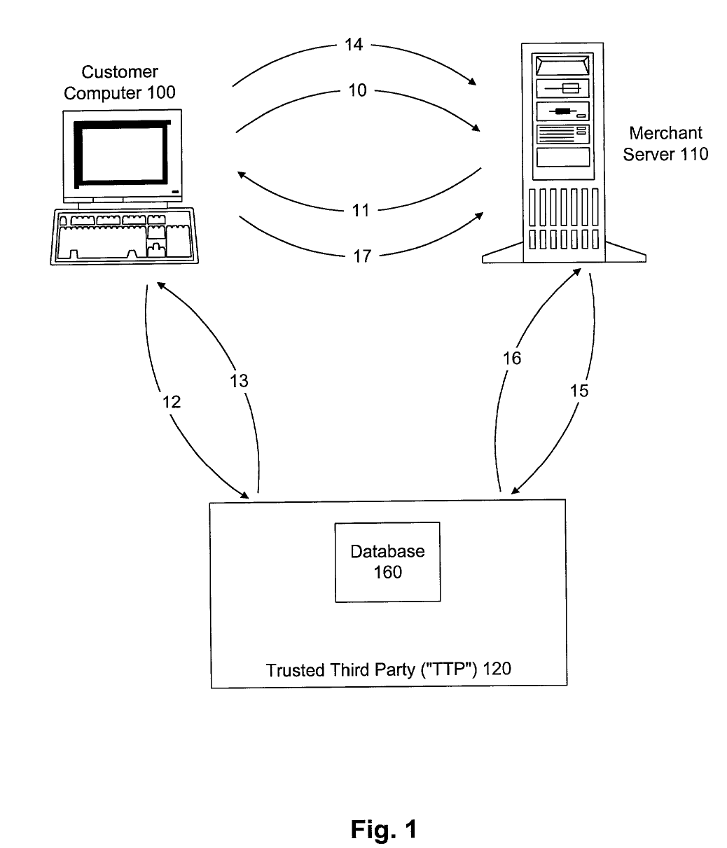

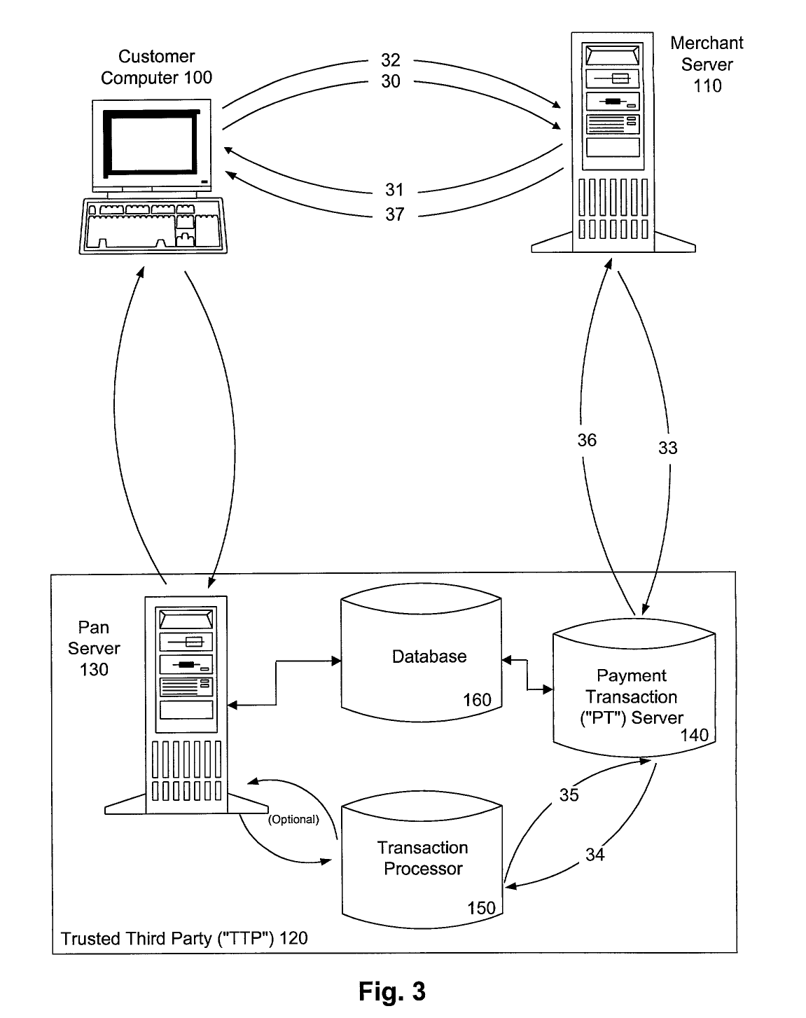

Methods and systems consistent with the present invention are depicted in FIG. 1. In one embodiment of the present invention, as shown in FIG. 1, a payment transaction is conducted between a customer at customer computer 100, a merchant via merchant server 110, and a trusted third party (“TPP”) 120. In general, TPP 120 acts as a transaction processor for payments over the Internet. TPP 120 may be a single entity or, as shown in FIG. 3, a collection of entities.

In FIG. 1, a customer is operating a web browser on customer computer 100. The browser uses HTML information transmitted by merchant server 110 to display the merchant's web pages on customer computer 100. A customer viewing a merchant's web site that wishes to purchase an advertised good or service (referred to hereinafter as “item”) indicates a selected item and indicates that the customer wishes to pay for the item using a trusted third party. The customer may indicate desire to pay using a trusted third party by, for example, clicking on an icon or other section of the displayed web page carrying identification of the trusted third party. The web browser on customer computer 100 interprets the customer's indication and transmits the selections to merchant server 110 as order information (step 10). Merchant server 110 receives the order information and transmits back to customer 100 transaction information, such as a payment price, currency code, merchant identification number (“merchant ID”), transaction identification number (“transaction ID”), transaction date and time, and description of goods sold. Merchant and transaction ID “numbers” may also include letters and symbols. In some embodiments consistent with the present invention, merchant server 110 digitally signs the merchant ID and/or the transaction ID so that either the customer or TTP 120 can authenticate the identify of the merchant.

Merchant server 110 triggers the presentation of a payment window to the customer (step 11). A payment window is a web page with designated fields for entering information for completing the transaction. In methods and systems consistent with the present invention, the payment window may be presented to the customer in one or more of the following ways:

Option 1. When payment is requested, merchant server 110 may invoke a TTP-signed object, such as a Java applet, ActiveX component, or other similar object, which is downloaded to and executed by the customer computer 100. To invoke the object or applet, merchant server 110 may download or otherwise transmit the object or applet to customer computer 100 and the object or applet runs locally on customer computer 100. The object or applet is signed by TTP 120, which means that the customer can verify that the code can be trusted to execute on her/his computer. In this case, all calculations are performed on customer computer 100 and the object or applet functions on behalf of the customer. The applet is signed by the TTP so that it can be trusted to execute without the customer risking her/his machine's integrity.

Option 2. When payment is requested, merchant server 120 may be prompted to look for a TTP-signed browser plug-in or other piece of software resident on customer computer 100 and invoke it. The browser plug-in or other software presents the payment to the customer. The browser plug-in or client software may have been installed, for example, at the time the customer applied for or activated a new account with TTP 120, or at any time during communication with TTP 120. In this case, the browser plug-in or other software runs locally on customer computer 100 and performs all calculations on customer computer 100.

Option 3. When payment is requested, the customer's web browser is “redirected” to a web page on TTP 120. The customer may be redirected by, for example, prompting the customer's web browser to locate the URL of a payment window running on TTP 120. The customer's web browser locates the URL and connects to TTP 120 using any commonly available means for establishing a secure connection, such as SSL. TTP 120 sends HTML instructions for displaying the payment window to the customer over the secure connection and any data entered into the payment window is transmitted to TTP 120 over the secure connection. Using Option 3, it is possible to have the user's interface look the same without any special software running on the customer's computer. All special software for implementing the present invention would be hosted on TTP 120 and TTP 120 could easily change the software code or make upgrades. Furthermore, redirection is possible on a variety of different platforms—effectively every browser that supports the SSL protocol.

Option 4. Alternatively, when payment is requested, merchant server 110 redirects the customer's web browser to a web page on TTP 120. The customer's web browser locates the URL and connects to TTP 120 using any commonly available means for establishing a secure connection, such as SSL. TTP 120 downloads a Java applet or browser plug-in or other software to customer computer 110 and invokes by it. The software is running on customer computer 110 and transmits all entered data to TTP 120.

Once the customer is presented with a payment window using one of the options described above, the customer enters into the payment window one or more payment tender types (such as, for example, ATM, prepaid card, debit card, credit card, and non-traditional payment tenders such as frequent flyer numbers (to use airline miles), Beenz, Flooz, Reward Points (to use membership reward points), tokens, gift certificates, etc.) and confidential payment information. Alternatively, the payment window may retrieve the customer's confidential payment information from a storage location on customer computer 100 or TTP 120, decrypt the information if it is stored in an encrypted format, and display the confidential payment information in the appropriate field or fields so that the customer does not have to enter the information manually.

In embodiments using options 1 or 2, the one or more payment tender types, confidential payment information, and transaction information are available to software operating on customer computer 110. In embodiments using options 3 or 4, the one or more payment tender types, confidential payment information, and transaction information are made available by TTP 120 (step 12).

In methods and systems consistent with the present invention, the customer's confidential payment information and transaction information is used to generate a Payment Authorization Number (or “PAN”). As described herein, the PAN may be generated by a TTP-signed applet, object, or browser plug-in operating on customer computer 110, or software operating on TTP 120. The software that generates the PAN (whether resident on customer computer 110 or TTP 120) will be referred to as the “PAN calculator.”

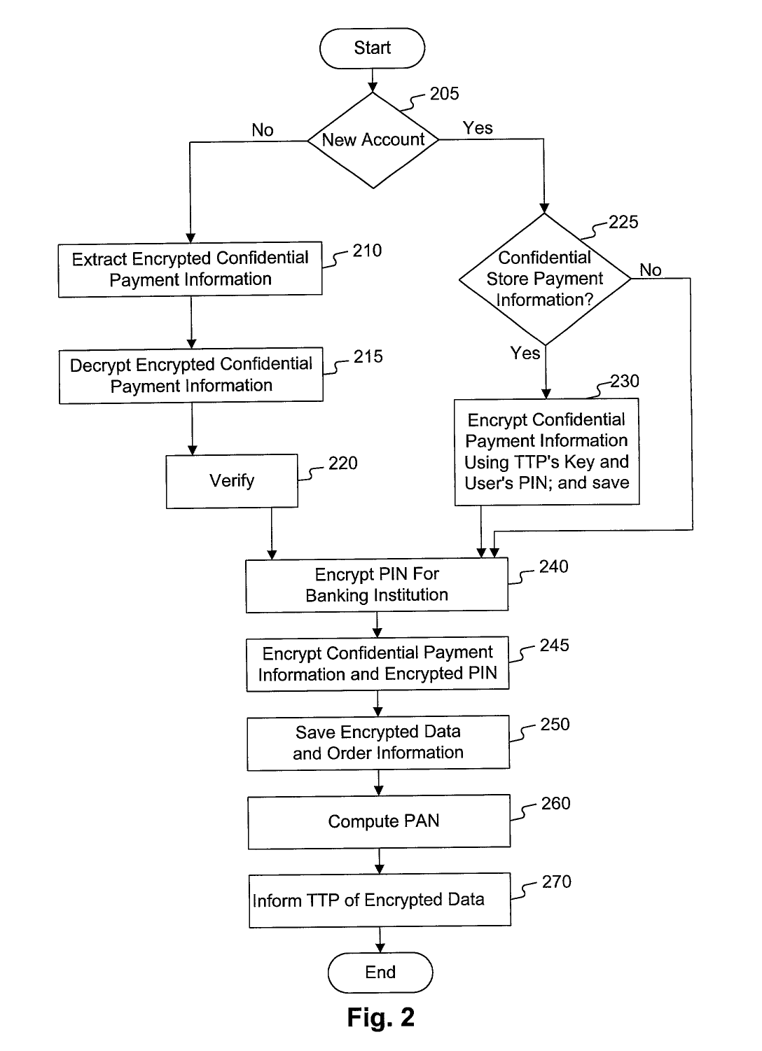

FIG. 2 shows an exemplary procedure performed by the PAN calculator. When the customer selects goods to buy and indicates payment by trusted third party, the PAN calculator checks to see if the customer's confidential payment information is already stored (step 205). If it is stored, the PAN calculator extracts the customer's stored confidential payment information (step 210). If the confidential payment information is encrypted, the confidential payment information may be decrypted using the PAN server's key and the customer's PIN (step 210). In this case, the customer inputs his or her PIN but does not need to enter other confidential payment information. The PAN calculator verifies that the PIN input by the customer results in a correct decryption of the card number or other payment authentication information (step 220).

If the customer is making the payment using a new payment tender type or new confidential payment information that TTP 120 has not seen before (step 205), the PAN calculator asks the customer if s/he wants to store the confidential payment information (step 225). If yes, the PAN calculator encrypts the confidential payment information using the PAN server's key and the user's PIN, and saves it either at the customer's computer or in the PAN server (step 230).

If the financial institution issuing the payment tender chosen by the customer requires use of a PIN, the PAN calculator encrypts the PIN using algorithms and keys specific to the issuing financial institution (steps 240). The PAN calculator performs encryption of the user-sensitive card/check number and other data as well as super-encryption of the encrypted PIN using a symmetric or asymmetric algorithm, e.g., Simple Symmetric Encryption Algorithm based on SHA-1 (SSEA-SHA1) (step 245). The PAN calculator saves the encrypted data and transaction information in the PAN server database (step 250) so as to keep record of the customer's confidential payment information.

The PAN calculator generates a PAN (step 260). In one embodiment of the present invention, the PAN is a digital signature of the customer's confidential payment information. The PAN may be generated, for example, using any known means for generating a digital signature. In one embodiment of the present invention, the PAN is generated by computing a Hash-based Message Authentication Code (such as “HMAC-SHA-1”) of the confidential payment information. Methods for generating HMACs are well known by those skilled in the art and are described in further detail, for example, in “Keying Hash Functions for Message Authentication,” Advances in Cryptology, Crypto 96 Proceedings, Lecture Notes in Computer Science, Vol., 1109 (Springer-Verlag, N. Koblitz, ed.), 1996, by Mihir Bellare et al.

In one exemplary method, the PAN may described as:

PAN=HMAC_{Key} (Customer confidential payment Information),

where HMAC is a Hash-based message authentication code, and the “key” is the customer's secret key. In general, the customer's “secret key” may be either a secret key shared between TPP 120 and the customer (as in a symmetric key cryptosystem) or the private key of a public-private key pair assigned to the customer (as in a asymmetric key cryptosystem). Since HMAC is a symmetric-key operation, the secret key in this case is shared between TTP 120 and the customer. In an alternative embodiment, the PAN may be a digital signature of the customer's confidential payment information and the transaction information. If the PAN is a digital signature of the customer's confidential payment information and the transaction information, the PAN is transaction-specific, that is, each transaction will have a unique PAN. When HMAC is used, this PAN may be described as:

PAN=HMAC_{Key} (Customer confidential payment Information/transaction information),

where HMAC is a Hash-based message authentication code, and the “key” is the customer's secret key.

Referring again to FIG. 1, customer computer 100 forwards the PAN to merchant server 110 (step 14). Merchant server 110 verifies that the transaction information has not been altered by, for example, retrieving the transaction information from its own database based on the specific transaction ID returned from the customer computer 110, and confirming that the amount, the currency code and (if present) the date/time and description of the transaction are the same as those returned from the customer computer 110. If the transaction information has not been altered, merchant server 110 signs the PAN and submits the PAN to TTP 120 (step 15). TTP 120 authenticates the PAN by recalculating it and comparing it with the submitted PAN. TTP 120 verifies the customer's confidential payment information by checking, for example, whether the cards used by the customer to create the signature were valid and had not expired, there are sufficient funds in the account, and the merchant accepts this method of payment. If the transaction information passes the proper validations, TTP 120 authorizes payment and executes payment to the merchant. TTP 120 notifies merchant server 110 that payment has been executed (step 16). The notification may include a digital signature of TTP 120 which can be verified by merchant server 110. When payment is received, merchant server 110 notifies the customer via customer computer 110 that payment has been received (step 17). If the transaction does not pass validation, TTP 120 sends an error message to merchant server 110, which notifies customer computer 110 that the payment was not successful.

In some embodiments of the present invention, TTP 120 is a collection of entities. As shown in FIG. 3, TPP 120 may comprise PAN server 130, Payment Transaction Server (“PT Server”) 140, Transaction Processor 150, and one or more databases, such as Database 160. PAN server 130 and PT Server 140 may be implemented on the same computer or separate computers.

FIG. 3 illustrates the steps of an embodiment where the PAN calculator is software running on customer computer 100, that is, either a TTP-signed object or applet invoked by merchant server 110 or a TTP-signed browser plug-in or other software. In FIG. 3, the customer indicates a selected item and indicates a desire to pay for the item using a trusted third party. The customer may indicate desire to pay, for example, by clicking on an icon or other section of the displayed web page carrying identification of the trusted third party. The web browser on customer computer 100 interprets the customer's indication and transmits the selections to merchant server 110 as order information (step 30). Merchant server 110 receives the order information and transmits back to customer 100 transaction information. In some embodiments of the present invention, merchant server 110 digitally signs the merchant ID and/or the transaction ID so that either the customer or TTP 120 can authenticate the identity of the merchant.

Merchant server 110 triggers the presentation of a payment window to the customer using option 1 or 2 described above with respect to FIG. 1 (step 31). Once the customer is presented with a payment window, the customer enters into the payment window one or more payment tender types and confidential payment types. Alternatively, the payment window may retrieve the customer's confidential payment information from a storage location on the customer computer 100 or TTP 120 and display the confidential payment information in the appropriate field or fields so that the customer does not have to enter the information manually. The one or more payment tender types, confidential payment information, and transaction information may optionally be transmitted to PAN Server 130 of TTP 120.

A PAN Calculator operating on customer computer 100 generates a PAN according to the steps of the method illustrated by FIG. 2. The PAN is a digital signature of the transaction and may be directly or indirectly related to the type of payment chosen. For example, if a customer elects to pay with a prepaid card, the digital signature sent to the merchant may be computed from the card number and PIN either specific to the card or the user. When a credit card is used, the signature may be created by PAN server 130 and may be bound to the credit card number in database 160. The PAN may be generated, for example, using any known means for generating a digital signature. In one embodiment of the present invention, the PAN is generated by computing a Hash-based Message Authentication Code (“HMAC”) of the customer's confidential payment information. In this case, the PAN may be described as:

PAN=HMAC_{Key} (Customer confidential payment Information),

where HMAC is a Hash-based message authentication code, and the “key” is the customer's secret key. In general, the customer's “secret key” may be either a secret key shared between TTP 120 and the customer (as in a symmetric key cryptosystem) or the private key of a public-private key pair assigned to the customer (as in a asymmetric key cryptosystem). Since HMAC is a symmetric-key operation, the secret key in this case is shared between TTP 120 and the customer. In an alternative embodiment, the PAN may be a digital signature of the customer's confidential payment information and the transaction information. If the PAN is a digital signature of the customer's confidential payment information and the transaction information, the PAN is transaction-specific, that is, each transaction will have a unique PAN. When HMAC is used, this PAN may be described as:

PAN=HMAC_{Key} (Customer confidential payment Information/transaction information),

where HMAC is a Hash-based message authentication code, and the “key” is the customer's secret key. Alternatively, the PAN may also comprise an encryption of the customer's confidential payment information as follows:

PAN={ENC_{Key1} (Customer's confidential payment information), HMAC_{Key2} (Customer's confidential payment information)},

where ENC is an encryption function (symmetric or asymmetric), and “key1” is a public key of PT Server 140 and “key2” is the customer's secret key.

Customer computer 100 forwards the PAN to merchant server 110 (step 32). Merchant server 110 verifies that the payment order information has not been altered. Merchant server 110 signs the PAN and submits a payment request and the signed PAN to PT Server 140 (step 33).

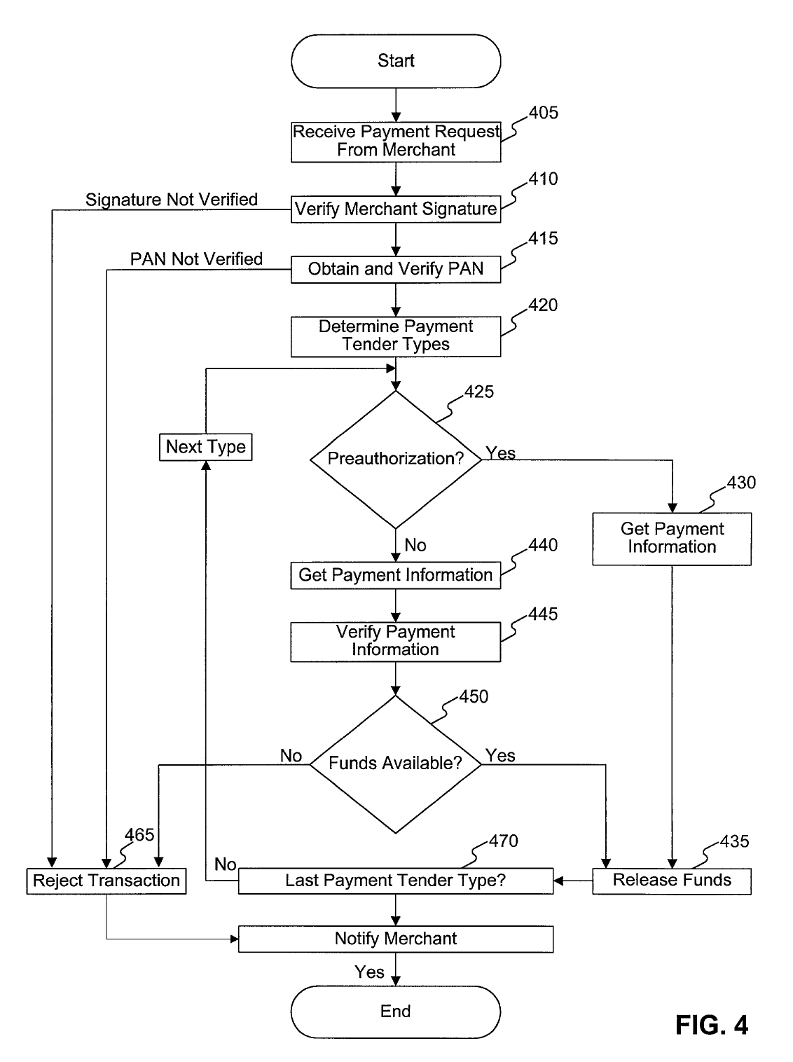

FIG. 4 illustrates the functions performed by PT Server 140. PT Server 140 receives the payment request with the accompanying PAN signed by merchant server 110 (step 405). PT Server 140 verifies the signature of the merchant (step 410). If the signature does not verify, the transaction is rejected (step 465). PT Server 140 obtains the PAN from the payment request and verifies it using the customer's secret key (shared with TTP 120) or the customer's public key (step 415). If the PAN cannot be verified, the transaction is rejected (step 465).

PT Server 140 may allow “split-tender” payments. A “split-tender payment” is one where a part of the purchase amount is charged to the one payment tender, such as the customer's credit card, and another part is charged to another tender, such as the customer's prepaid card, therefore multiple tender types can be used per transaction. In step 420, PT Server 140 determines the payment tender types specified by the customer. For each payment tender type specified, PT Server 140 checks whether payment with the payment tender type has been preauthorized (step 425). If payment with the payment tender type has been preauthorized, PT Server 140 gets the customers confidential payment information and the transaction information (step 430) and releases the funds by sending instructions to Transaction Processor 150 to execute the payment transaction (step 435) (also FIG. 3, step 34).

If payment with a payment tender type was not preauthorized, PT Server 140 gets the customer's confidential payment information and the transaction information (step 440) and verifies the information (step 445). PT Server 140 transmits the customer's confidential payment information to Transaction Processor 150 (FIG. 3, step 34). Transaction Processor 15 receives payment requests from PT Server 140 (and in some cases, from PAN Server 120), and redirects them to the financial institution that issued the chosen payment tender. The financial institution verifies the transaction in real time and sends the request back to Transaction Processor 150. If the funds are available to clear the transaction, Transaction Processor 150 authorizes payment and informs PT Server 140 (FIG. 3, step 35).

Returning now to FIG. 4, if Transaction Processor 150 notifies PT Server 140 that sufficient funds are available to clear the transaction (step 450), the funds are released (step 435). If sufficient funds are not available to clear the transaction, an error message is returned to PT Server 140. PT Server 140 updates the transaction history information saved in a transaction history database. Steps 425 through 470 are repeated for each payment tender type (step 480). PT Server 140 computes a signature of the particular transaction and transmits the signed transaction to merchant server 110 notifying the merchant that funds have been released or that payment was unsuccessful (step 435) (also FIG. 3, step 36).

Merchant server 110 notifies the customer via customer computer 100 that payment was successful or unsuccessful (step 37).

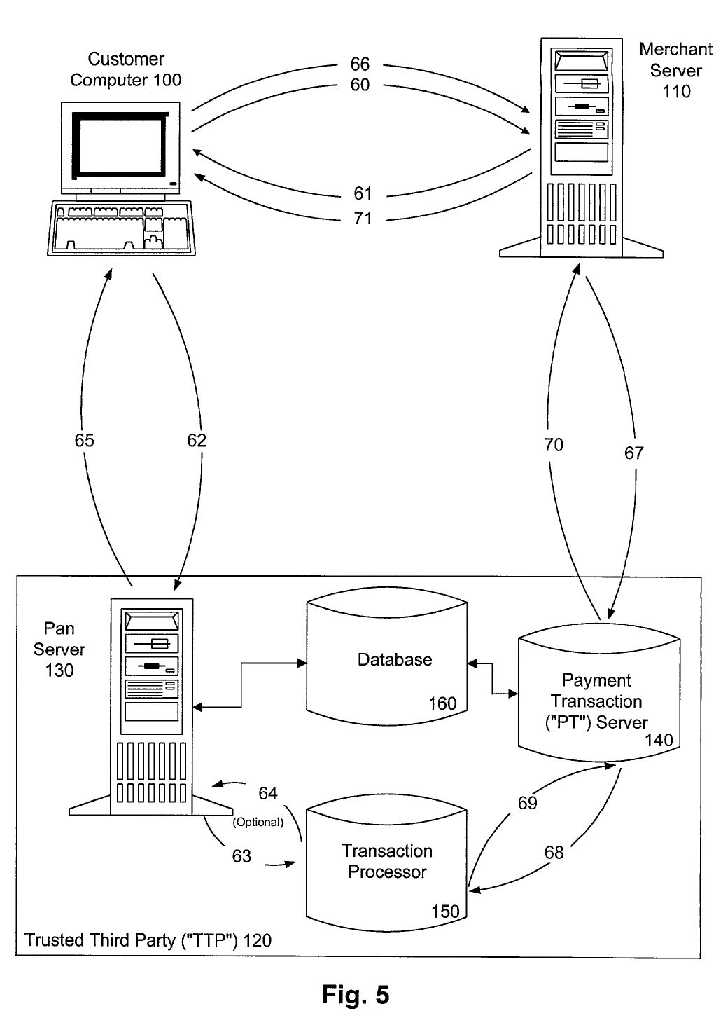

FIG. 5 illustrates an embodiment where the PAN calculator is resident on TTP 120. As in the embodiments above, the customer indicates a selected item and indicates a desire to pay for the item using a trusted third party. The customer may indicate desire to pay, for example, by clicking on an icon or other section of the displayed web page carrying identification of the trusted third party. The web browser on customer computer 100 interprets the customer's indication and transmits the selections to merchant server 110 as order information (step 60). Merchant server 110 receives the order information and transmits back to customer 100 transaction information. In some embodiments of the present invention, merchant server 110 digitally signs the merchant ID and/or the transaction ID so that either the customer or TTP 120 can authenticate the identity of the merchant.

Merchant server 110 triggers the presentation of a payment window to the customer using option 3 or 4 described above with respect to FIG. 1 (step 61). Once the customer is presented with a payment window, the customer enters into the payment window one or more payment tender types and confidential payment types. Alternatively, the payment window may retrieve the customer's confidential payment information from a storage location on the customer computer 100 or TTP 120 and display the confidential payment information in the appropriate field or fields so that the customer does not have to enter the information manually. The one or more payment tender types, confidential payment information, and transaction information are to PAN Server 130 of TTP 120 (step 62).

Optionally, PAN Server 130 may request preauthorization of the payment amount from Transaction Processor 150 (step 63). Transaction Processor 150 may query the account issuing financial institution to confirm that sufficient funds will be available (in the case of a debit account) or whether a charge limit is exceed (in the case of a credit account). Transaction Processor 150 notifies PAN Server 130 whether the payment is preauthorized or rejected and may also provide other information, such as balance information (step 64).

A PAN Calculator operating on PAN Server 130 generates a PAN according to the steps of the method illustrated by FIG. 2 The PAN may be generated, for example, using any known means for generating a digital signature. In one embodiment of the present invention, the PAN is generated by computing a Hash-based Message Authentication Code (“HMAC”) of the customer's confidential payment information. In this case, the PAN may be described as:

PAN=HMAC_{Key} (Customer confidential payment Information),

where HMAC is a Hash-based message authentication code, and the “key” is the TTP's secret key. In general, the customer's “secret key” may be either a secret key shared between TTP 120 and the customer (as in a symmetric key cryptosystem) or the private key of a public-private key pair associated with the customer (as in an asymmetric key system). Since HMAC is a symmetric-key operation, the secret key in this case is shared between TTP 120 and the customer. In an alternative embodiment, the PAN may be a digital signature of the customer's confidential payment information and the transaction information. If the PAN is a digital signature of the customer's confidential payment information and the transaction information, the PAN is transaction-specific, that is, each transaction will have a unique PAN. When HMAC is used, this PAN may be described as:

PAN=HMAC_{Key} (Customer confidential payment Information/transaction information),

where HMAC is a Hash-based message authentication code, and the “key” is the customer's secret key. Alternatively, the PAN may also comprise an encryption of the customer's confidential payment information as follows:

PAN={ENC_{Key1} (Customer's confidential payment information), HMAC_{Key2} (Customer's confidential payment information)},

where ENC is an encryption function (symmetric or asymmetric), and “key1” is a public key of PT Server 140 and “key2” is the customer's secret key.

PAN Server 130 transmits the PAN to Customer computer 100 (step 65), which forwards the PAN to merchant server 110 (step 66). Merchant server 110 verifies that the payment order information has not been altered. Merchant server 110 signs the PAN and submits a payment request and the signed PAN to PT Server 140 (step 67).

FIG. 4 illustrates the functions performed by PT Server 140. PT Server 140 receives the payment request with the accompanying PAN signed by merchant server 110 (step 405). PT Server 140 verifies the signature of the merchant (step 410). If the signature does not verify, the transaction is rejected (step 465). PT Server 140 obtains the PAN from the payment request and verifies it using the customer's secret key (shared with TTP 120) or the customer's public key (step 415). If the PAN cannot be verified, the transaction is rejected (step 465).

PT Server 140 may allow “split-tender” payments. A “split-tender payment” is one where a part of the purchase amount is charged to the one payment tender, such as the customer's credit card, and another part is charged to another tender, such as the customer's prepaid card, therefore multiple tender types can be used per transaction. In step 420, PT Server 140 determines the payment tender types specified by the customer. For each payment tender type specified, PT Server 140 checks whether payment with the payment tender type has been preauthorized (step 425). If payment with the payment tender type has been preauthorized, PT Server 140 gets the customer's confidential payment information and the transaction information (step 430) and releases the funds by sending instructions to Transaction Processor 150 to execute the payment transaction (step 435) (also FIG. 3, step 68).

If payment with a payment tender type was not preauthorized, PT Server 140 gets the customer's confidential payment information and the transaction information (step 440) and verifies the information (step 445). PT Server 140 transmits the customer's confidential payment information to Transaction Processor 150 (FIG. 3, step 68). Transaction Processor 15 receives payment requests from PT Server 140 (and in some cases, from PAN Server 120), and redirects them to the financial institution that issued the chosen payment tender. The financial institution verifies the transaction in real time and sends the request back to Transaction Processor 150. If the funds are available to clear the transaction, Transaction Processor 150 authorizes payment and informs PT Server 140 (FIG. 3, step 69).

Returning now to FIG. 4, if Transaction Processor 150 notifies PT Server 140 that sufficient funds are available to clear the transaction (step 450), the funds are released (step 435). If sufficient funds are not available to clear the transaction, an error message is returned to PT Server 140. PT Server 140 updates the transaction history information saved in a transaction history database. Steps 425 through 470 are repeated for each payment tender type (step 480). PT Server 140 computes a signature of the particular transaction and transmits the signed transaction to merchant server 110 notifying the merchant that funds have been released or that payment was unsuccessful (step 435) (also FIG. 3, step 70). Merchant server 110 notifies the customer via customer computer 100 that payment was successful or unsuccessful (step 71).

If the PAN contains the payment signature but does not contain the encryption of the customer's confidential payment information, PT Server 140 can obtain the customer's confidential payment information through shared database 160 to obtain the necessary information needed to proceed with the payment transaction.

In some embodiments consistent with the present invention, the customer's secret key is provided by PAN server 130 and shared with PT server 140 such that PT Server 140 can verify the PAN. Alternatively, the customer's secret key is not shared by PT Server 140, but PT Server 140 can verify the PAN by using the customer's public key.

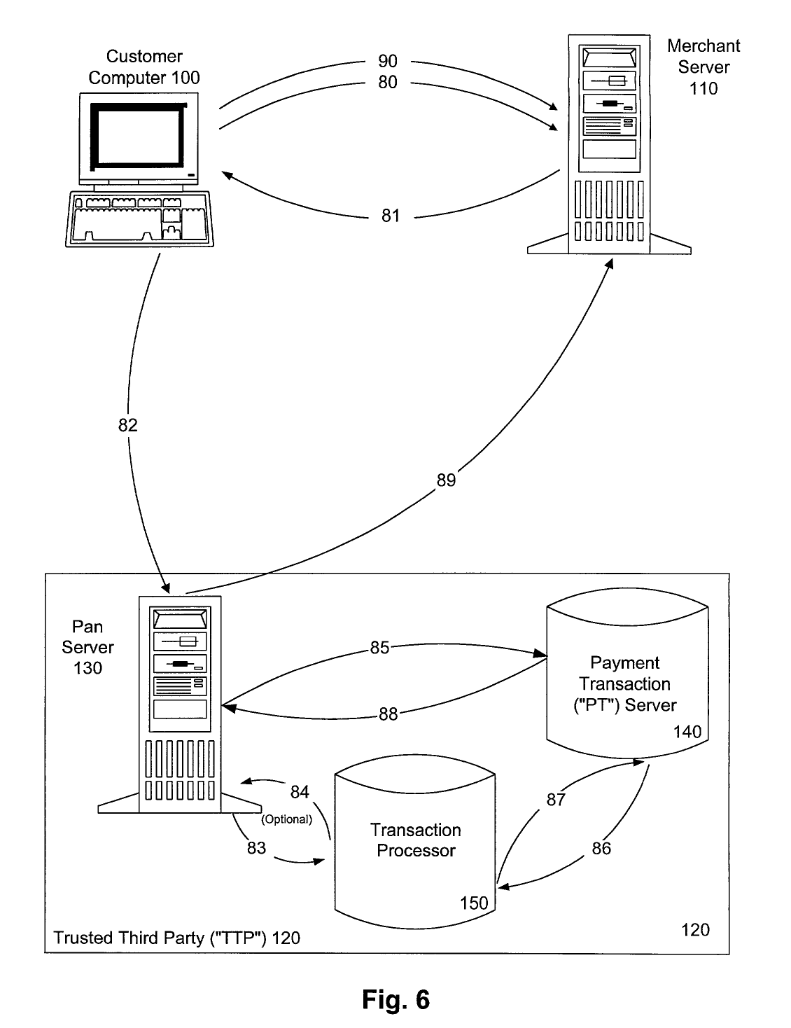

FIG. 6 illustrates an embodiment consistent with the present invention where the merchant performs only one contact with the TTP in a mutually-signed communication exchange. Specifically, as shown in FIG. 6, a customer indicates a selected item and indicates a desire to pay for the item using a trusted third party. The customer's web browser on customer computer 100 interprets the customer's indication and transmits the selections to merchant server 110 as order information (step 80). Merchant server 110 receives the order information and transmits back to customer computer 100 the order information and transaction information (step 81). Merchant server 110 may optionally digitally sign the order information, the transaction information, or both. Merchant server 110 redirects the customer's web browser to Customer Computer 100 and triggers the presentation of a payment window to the customer (step 82).

In methods and systems consistent with the present invention, the payment window may be generated using options 3 and 4 described in more detail above. Once the customer is presented with a payment window, the customer enters into the payment window one or more payment tender types and confidential payment types. Alternatively, the payment window may retrieve the customer's confidential payment information from a storage location on the customer computer 100 or TTP 120 and display the confidential payment information in the appropriate field or fields so that the customer does not have to enter the information manually. The one or more payment tender types, confidential payment information, and transaction information are transmitted to PAN Server 130 of TTP 120 (step 82).

Optionally, PAN Server 130 may request preauthorization of the payment amount from Transaction Processor 150 (step 83). Transaction Processor 150 may query the account issuing financial institution to confirm that sufficient funds will be available (in the case of a debit account) or whether a charge limit is exceed (in the case of a credit account). Transaction Processor 150 notifies PAN Server 130 whether the payment is preauthorized or rejected and may also provide other information, such as balance information (step 84).

In this embodiment, generating a PAN is optional. If generated, PAN Calculator operating on PAN Server 130 generates a PAN according to the steps of the method illustrated by FIG. 2. The PAN may be generated, for example, using any known means for generating a digital signature. In one embodiment of the present invention, the PAN is generated by computing a Hash-based Message Authentication Code (“HMAC”) of the customer's confidential payment information. In this case, the PAN may be described as:

PAN=HMAC_{Key} (Customer confidential payment Information),

where HMAC is a Hash-based message authentication code, and the “key” is the TTP's secret key. In general, the TTP's “secret key” may be either a secret key shared between TPP 120 and PT Server 140 (as in a symmetric key cryptosystem) or the private key of a public-private key pair assigned to the customer (as in a asymmetric key cryptosystem). Since HMAC is a symmetric-key operation, the secret key in this case is shared between TTP 120 and PT Server 140. In an alternative embodiment, the PAN may be a digital signature of the customer's confidential payment information and the transaction information. If the PAN is a digital signature of the customer's confidential payment information and the transaction information, the PAN is transaction-specific, that is, each transaction will have a unique PAN. When HMAC is used, this PAN may be described as:

PAN=HMAC_{Key} (Customer confidential payment Information/transaction information),

where HMAC is a Hash-based message authentication code, and the “key” is the customer's secret key. Alternatively, the PAN may also comprise an encryption of the customer's confidential payment information as follows:

PAN={ENC_{Key1} (Customer's confidential payment information), HMAC_{Key2} (Customer's confidential payment information)},

where ENC is an encryption function (symmetric or asymmetric), and “key1” is a public key of PT Server 140 and “key2” is the customer's secret key.

PAN Server 130 transmits the PAN to PT Server 140 (step 85). PT Server 140 receives the payment request with the accompanying PAN from PAN Server 130. PT Server 140 verifies the PAN using the customer's secret key (shared with TTP 120) or the customer's public key. If the PAN cannot be verified, the transaction is rejected.

PAN server 130 sends a payment request to PT server 140 (step 86). If pre-authorization or account balance information was received in step 84, the pre-authorization and/or account balance information may be also transmitted to PT Server 140 in step 85. If PT server 140 receives a preauthorization in step 85, PT Server 140 sends a request to Transaction Processor 150 to execute the payment transaction (step 86). If pre-authorization or account balance information was received in step 84, the pre-authorization and/or account balance information may be also transmitted to Transaction Processor 150. Transaction Processor 150 authorizes payment and informs PT server 140 (step 87). PT server 140 confirms payment to PAN Server 130 (step 88). PAN Server 130 returns a PAN to Merchant Server 110 (step 89). The PAN is a digital signature of the customer's confidential payment information and created by PAN Server 130 using one of the methods described above. Merchant server 110 receives the PAN and verifies PAN Server 130's signature. If payment was successful, merchant server 110 informs the customer of successful payment (step 90). If payment was unsuccessful, merchant server 110 informs the customer that the payment was rejected or any error messages (step 90).

By redirecting the customer to PAN Server's site, PAN servers are able to perform computations on behalf of the customer in addition to PAN generation such as, for example.

1. Other Keyed operations: In addition to the above, PAN Server can use other symmetric or asymmetric keys to perform operations on behalf of the client. In other words, the PAN Server can act as a trusted third party for any other computations involving keys for the customer. These keys can either be provided by the customer, or stored by the PAN Server and indexed by the user's card number(s) or other indexes provided by the user. For example, the PAN Server can act as a remote pin pad to encrypt a customer's ATM PIN using DES, for Internet transactions with Debit or ATM cards. A pin pad is a device used by customers to enter PINS. Some pin pads, such as the PINpad 1000, support Message Authentication Code (“MAC”) and use MACs to protect debit card transaction during its transfer to a host.

2. Wallet operations: The PAN Server can also act as a wallet for customers. For example, customers can store their credit card information in the redirected PAN Server window, and the window can then fill this information automatically for the customer every for purchase.

3. Accommodation of a new payment tender: The PAN server can accommodate, due to its nature, new payment tenders, combinations of more than one payment tenders, and even client-based payment solutions. This is because it is built as a web page, and therefore it can perform all the operations that a merchant's site could. Possible additions are: detection of client hardware/software and decision as to whether to use a client-based HSM (such as a smart card) for payments; detection of client platform and modification of behavior (e.g., for WAP payments); and accommodation of other payment signatures and message sets (e.g., for SET support).

The PAN server may or may not be connected to the TTP2 payment server. The fact that it can be independent allows it to be run from a separate server and to be secured in a separate environment.

In addition to the above, the wallet can also allow customers to view card balances (and in case of prepaid card, original card face value), view card transaction history, change card PIN, and in general perform all the operations that could otherwise be performed by visiting PAN Server's or an affiliate's web site. In the case of html redirection, this boils down to the front-end interface (html page design) of the wallet, since the customer already is at the PAN Server's or an affiliate's web site. In the case of the plug-in or applet, additional functionality is required to allow those pieces to communicate to PAN Server's website to obtain or submit the information required for each action.

Methods and systems consistent with the present invention provide security to financial institutions and merchants by guarding against parallel attacks. If, for example, a customer tries to use the full amount of a card on two different web sites at the same time (i.e., double-spend) only one transaction will succeed, because transactions are cleared in real time through a single database. Therefore, if two transactions for the same card arrive in parallel, they will be sequenced; the first one will succeed while the second will fail with an “insufficient funds” message. Furthermore, methods and systems consistent with the present invention guard against adversarial changes of customer's confidential payment information. An adversary cannot alter the payment order information because the merchant will detect the changes and abort the transaction. Methods and systems consistent with the present invention may also provide immunity against replay attacks. A reply attack is a situation where the merchant sends the same payment request more than once. Although the payment request from the merchant to PT Server 140 in step 27 of FIG. 2 can be replayed either legitimately (for example, if the communication failed the first time) or by an adversary, the replay will not result in duplicate charges because no payment action is taken if the same PAN has been seen in the past. Because the PAN is unique for every transaction, PT server 140 can determine if the PAN is being used again. Methods and systems consistent with the present invention protect a merchant against nonrepudiation through the use of digital signatures. An existentially unforgeable signature is created at payment time and guarantees user security as long as the tender type used cannot be expanded (e.g., the adversary cannot guess other parties'credit card numbers and PINs, or guess/forge check numbers). This is realized by not allowing the merchant to change the customer's confidential payment information of the customer.

Methods and systems consistent with the present invention allow a customer to remain anonymous to the merchant. In the course of the payment transaction, the merchant only sees the digital signature of the customer (PAN) and, as long as the merchant receives payment, does not need to verify the customer's identity. If the customer desires full anonymity, for example, from all parties including the trusted third party, the customer may use other payment methods, such as a prepaid card or blind signature-based digital signature.

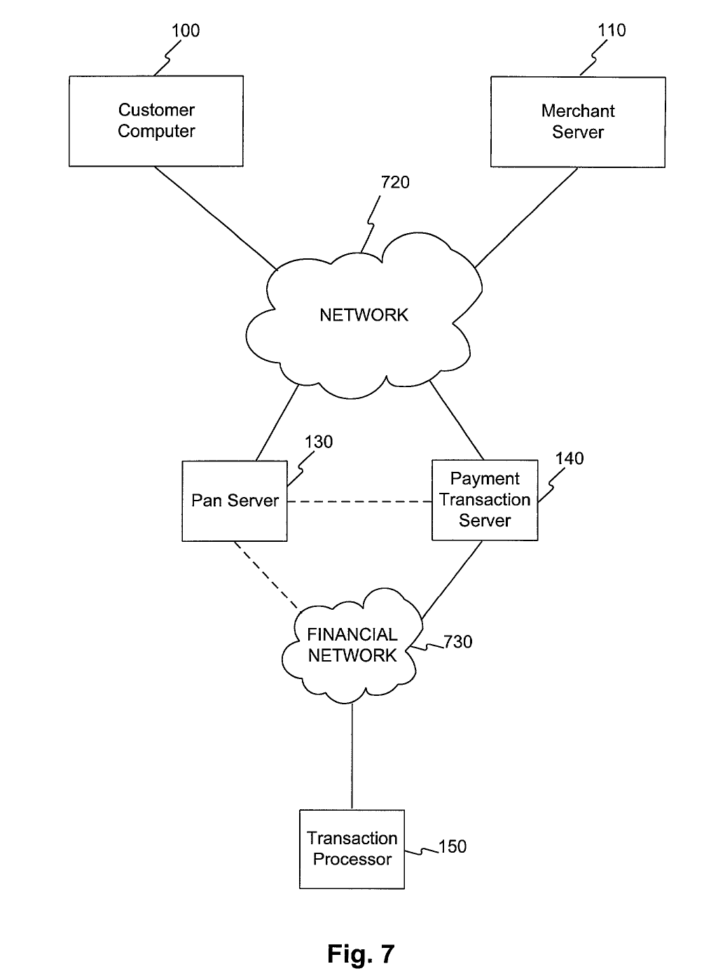

FIG. 7 shows an exemplary system configuration consistent with the present invention. Systems consistent with the present invention comprise a customer computer 100 and a merchant server 110 connected via an insecure network 720 with a PAN server 130 and a payment transaction (“PT”) server 140. PT Server 140 is connected to Transaction Processor 150, via a secure financial network 730. Financial network 730 may be physically secure or secured via the use of commonly recognized protocols for secure transmission, such as SSL. Transaction Processor 150 may optionally be connected with PAN server 130 via financial network 730. Alternatively or additionally, PAN server 130 and PT Server 140 may be connected directly (that is, not via network 720 or financial network 730).

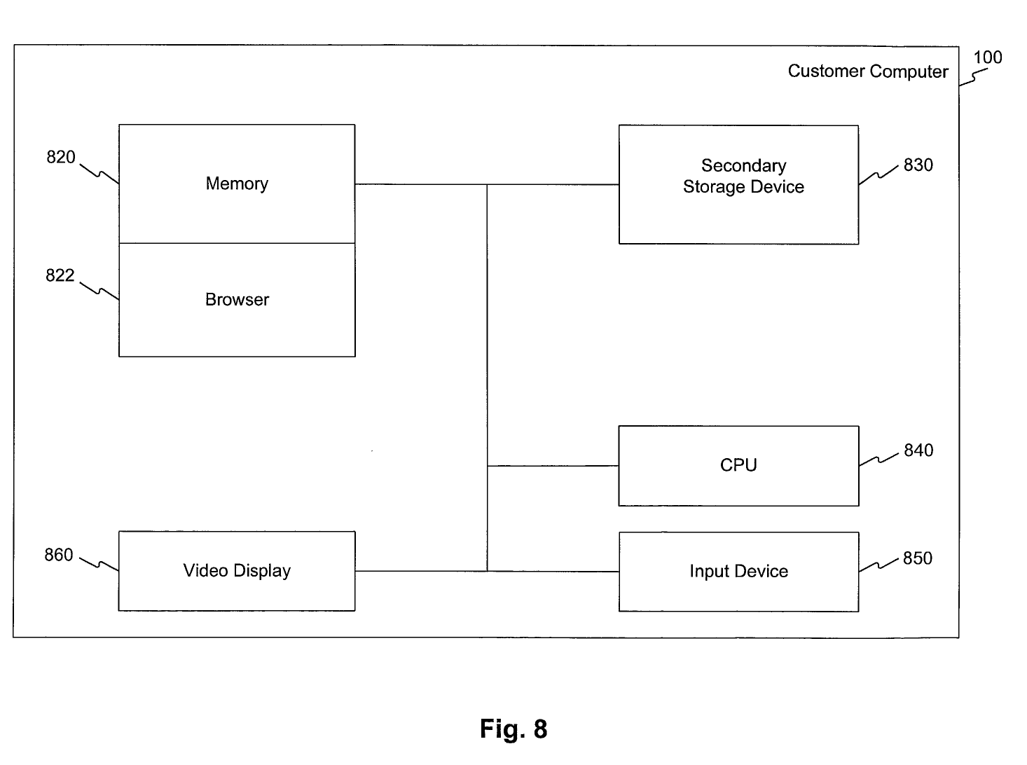

A customer uses customer computer 100 to provide various information to merchant server 120 and PAN server 130. Customer computer 100 may be any device comprising the components shown in FIG. 8, including, but not limited to, a traditional personal computer, a WAP-enabled cellular phone, webTV™-type device, hand-held personal digital assistant, such as a Palm Pilot™, or other similar device.

PAN server 130 transmits and receives secure web pages from a browser on customer computer 100 using HTML or Java. PAN server 113 also contains a database that may store information associated with the wallets. The web pages (front-end) and databases (back-end) are further described below.

Merchant server 110 authorizes transactions using a merchant toolkit (not shown). Merchant server 110 is also capable of transmitting and receiving secure web pages from a browser on customer computer 100. Transaction processor 150 can be a well-known financial entity used to process payments (e.g., credit card, debit card, or ATM payment) at a store location (point of sale).

Although only one customer computer 100 is depicted, one skilled in the art will appreciate that the system may contain many more customer computers and additional customer sites. Similarly, plural merchant servers 110 and sites can be accommodated in the system.

As shown in FIG. 8, customer computer 110 may contain a memory 820, a secondary storage device 830, a central processing unit (CPU) 840, an input device 850, and a video display 860. Memory 820 includes browser 822 that allows users to interact with various servers by transmitting and receiving files.

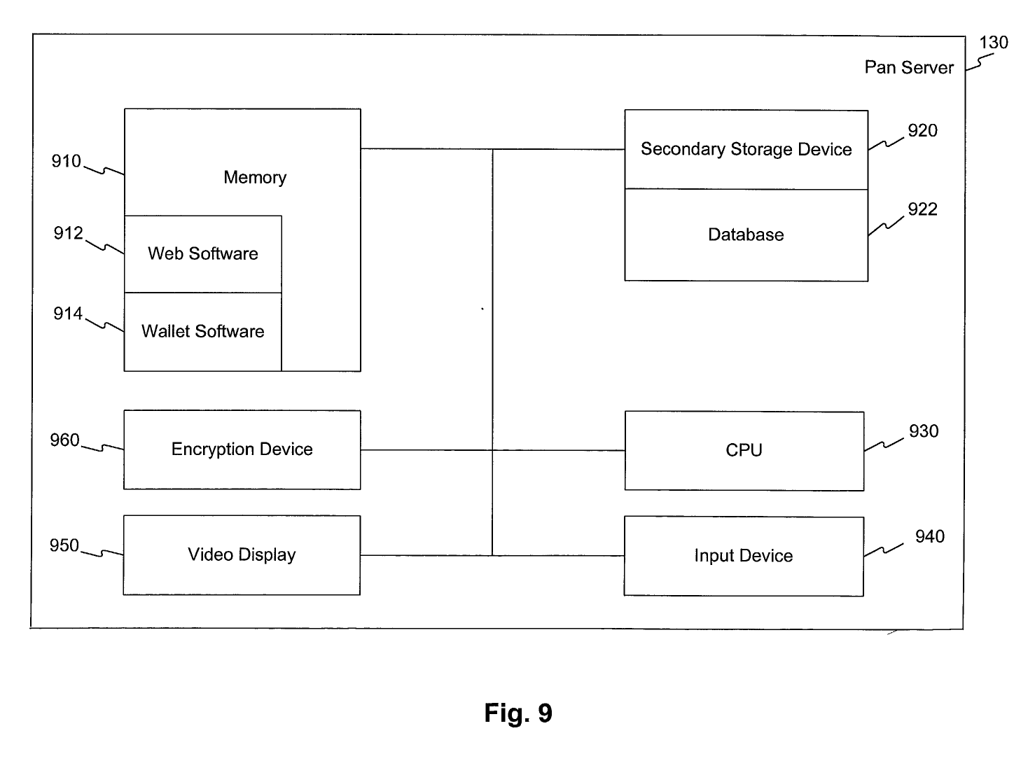

As shown in FIG. 9, PAN server 130 may include a memory 910, a secondary storage device 920, a CPU 930, an input device 940, an optional video display 950, and an optional encryption device 960. Memory 910 includes web software 912 and wallet software 914. Web software 912 transmits and receives web pages in a secure manner. Although web software is described in this particular embodiment of the PAN server, the PAN server may interact with customers in other ways such as, voice prompts, call centers, or kiosks. Wallet software 914 creates wallets for various customers. Wallet software 914 contains various keys used to authorize and/or encrypt a customer's confidential payment information (e.g., card numbers and PINs). The encrypted key is used to transmit secure information to and from customers and merchants.

Secondary storage device 920 optionally contains a database 922 that stores wallet information, such as card numbers, merchant data (e.g., ID and transaction requests), information about various payments, and signatures with respect to the wallet.

The above-described embodiments according to the present invention may be conveniently implemented using conventional general purpose digital computers programmed according to the teachings of the present specification, as will be apparent to those skilled in the computer art. Appropriate software coding can readily be prepared by skilled programmers based on the teachings of the present disclosure, as will be apparent to those skilled in the software art. Such a software package can be a computer program product that employs a storage medium including stored computer code which is used to program a computer to perform the disclosed function and process of the present invention. Also, what is described above as being stored in a memory may be stored on or read from other computer-readable media, such as secondary storage devices, like hard disks, floppy disks, and CD-ROM; a carrier wave received from a network like the Internet; or other forms of ROM or RAM.

In addition to those already mentioned above, persons of ordinary skill will realize that many modifications and variations of the above embodiments may be made without departing from the novel and advantageous features of the present invention.

Accordingly, all such modifications and variations are intended to be included within the scope of the appended claims. The specification and examples are only exemplary. The following claims define the true scope and sprit of the invention.

We claim:

1. A method for securing payment over a network from a customer to a merchant, performed by a trusted party component, the method comprising:
receiving a request from the customer to pay the merchant, the request including a transaction information;
obtaining confidential payment information of the customer;
generating payment authentication information based on the confidential payment information; and
facilitating payment to the merchant without disclosing the confidential payment information of the customer to the merchant by transmitting instructions to pay the merchant on behalf of the customer and the payment authentication information to a payment component.

2. The method of claim 1, wherein the payment authentication information is generated based on the confidential payment information and the transaction information.

3. The method of claim 1, wherein the payment authentication information comprises a digital signature determined based on a secret key of the customer.

4. The method of claim 1, wherein the trusted party component is a computer program signed by a trusted third party, spawned by a first computer of the merchant, and executed on a second computer of the customer.

5. The method of claim 1, wherein the trusted party component is a computer program signed by a trusted third party, installed in a first computer of the customer, and invoked by a second computer of the merchant.

6. The method of claim 1, wherein the trusted party component executes on a computer of a trusted third party.

7. The method of claim 1, wherein the trusted party component is a computer program spawned by or downloaded from a first computer of a trusted third party and executed on a second computer of the customer.

8. The method of claim 1, further comprising:
verifying, by the payment component, the payment authentication information.

9. The method of claim 8, further comprising:
paying the merchant, if the payment authentication information is verified.

10. The method of claim 9, wherein the transaction information includes a transaction amount and paying comprises instructing at least one financial institution to pay the merchant at least part of the transaction price.

11. The method of claim 1, further comprising:
notifying the customer that the merchant has been paid.

12. The method of claim 1, further comprising:
providing the merchant with a transaction history report including the payment authentication information.

13. The method of claim 1, wherein the transaction information includes a transaction amount and the method further comprises:
requesting pre-authorization for the transaction amount from at least one financial institution; and
transmitting the pre-authorization to the payment component with the instructions to pay the merchant on behalf of the customer and the payment authentication information.

14. The method of claim 1, further comprising:
authenticating the confidential payment information as associated with the customer; and
storing the confidential payment information in a database accessible to the payment component.

15. The method of claim 14, the method further comprising:
obtaining the confidential payment information from the database; and
verifying, by the payment component, the payment authentication information and the confidential payment information.

16. The method of claim 15, further comprising:
paying the merchant, if the payment authentication information and the confidential payment are verified.

17. A method for securing payment from a customer to a merchant over a network, performed by a first trusted party component, the method comprising:
receiving a request from the customer to pay the merchant;
obtaining confidential payment information associated with the customer;
generating payment authentication information based on the confidential payment information;
transmitting the payment authentication information to the merchant;
receiving from the merchant the payment authentication information with a merchant signature;
verifying the merchant signature and the payment authentication information; and
paying the merchant on behalf of the customer.

18. The method of claim 17, wherein the payment authentication information is generated based on the confidential payment information and transaction information

19. The method of claim 17, wherein the payment authentication information comprises a digital signature of the confidential payment information and transaction information.

20. The method of claim 19, wherein the payment authentication information with merchant signature is received by a second trusted party component and the second trusted party component verifies the merchant signature and the payment authentication information.

21. The method of claim 20, further comprising:
paying the merchant, by the second trusted party component, on behalf of the customer.

22. The method of claim 20, further comprising:
generating, by the first trusted component, an encryption of the confidential payment information and transaction information;
transmitting the encryption to the second trusted party component, who uses the encryption to verify the merchant signature and the payment authentication information.

23. The method of claim 22, wherein transmitting the encryption to the second trusted party component is performed by saving the encryption in a database accessible to the first trusted party component and the second trusted party component.

24. A method for securing payment from a customer to a merchant over a network, performed by a trusted party component, the method comprising:
receiving an instruction from the customer to pay the merchant with a merchant signature;
obtaining confidential payment information of the customer;
verifying the merchant signature; and,
paying the merchant based on the confidential payment information, if the merchant signature is verified.

25. The method of claim 24, further comprising:
generating payment authentication information based on the confidential payment information and transaction information; and
transmitting the payment authentication information with a third-party signature to the merchant.

26. The method of claim 25, wherein paying the merchant comprises transferring funds from an account related to the customer to an account related to the merchant.

27. A computer-readable medium containing instructions for causing a computer to perform a method for securing payment over a network from a customer to a merchant, the method comprising:
receiving a request from the customer to pay the merchant, the request including a transaction information;
obtaining confidential payment information of the customer;
generating payment authentication information based on the confidential payment information; and
facilitating payment to the merchant without disclosing the confidential payment information of the customer to the merchant by transmitting instructions to pay the merchant on behalf of the customer and the payment authentication information to a payment component.

28. The medium of claim 27, wherein the payment authentication information is generated based on the confidential payment information and the transaction information.

29. The medium of claim 27, wherein the payment authentication information comprises a digital signature determined based on a secret key of the customer.

30. The medium of claim 27, wherein the trusted party component is a computer program signed by a trusted third party, spawned by a first computer of the merchant, and executed on a second computer of the customer.

31. The medium of claim 27, wherein the trusted party component is a computer program signed by a trusted third party, installed in a first computer of the customer, and invoked by a second computer of the merchant.

32. The medium of claim 27, wherein the trusted party component executes on a computer of a trusted third party.

33. The medium of claim 27, wherein the trusted party component is a computer program spawned by or downloaded from a first computer of a trusted third party and executed on a second computer of the customer.

34. The medium of claim 27, further comprising:
verifying, by the payment component, the payment authentication information.

35. The medium of claim 27, further comprising:
paying the merchant, if the payment authentication information is verified.

36. The medium of claim 27, wherein the transaction information includes a transaction amount and paying comprises instructing at least one financial institution to pay the merchant at least part of the transaction price.

37. The medium of claim 27, further comprising:
notifying the customer that the merchant has been paid.

38. The medium of claim 27, further comprising:
providing the merchant with a transaction history report including the payment authentication information.

39. The medium of claim 27, wherein the transaction information includes a transaction amount and the method further comprises:
requesting pre-authorization for the transaction amount from at least one financial institution; and
transmitting the pre-authorization to the payment component with the instructions to pay the merchant on behalf of the customer and the payment authentication information.

40. The medium of claim 27, further comprising:
authenticating the confidential payment information as associated with the customer; and
storing the confidential payment information in a database accessible to the payment component.

41. The medium of claim 40, the method further comprising:
obtaining the confidential payment information from the database; and
verifying, by the payment component, the payment authentication information and the confidential payment information.

42. The medium of claim 41, further comprising:
paying the merchant, if the payment authentication information and the confidential payment are verified.

43. A computer-readable medium containing instructions for causing a computer to perform a method for securing payment over a network from a customer to a merchant, the method comprising:
receiving a request from the customer to pay the merchant;
obtaining confidential payment information associated with the customer;
generating payment authentication information based on the confidential payment information;
transmitting the payment authentication information to the merchant;
receiving from the merchant the payment authentication information with a merchant signature;
verifying the merchant signature and the payment authentication information; and
paying the merchant on behalf of the customer.

44. The medium of claim 43, wherein the payment authentication information is generated based on the confidential payment information and transaction information

45. The medium of claim 43, wherein the payment authentication information comprises a digital signature of the confidential payment information and transaction information.

46. The medium of claim 43, wherein the payment authentication information with merchant signature is received by a second trusted party component and the second trusted party component verifies the merchant signature and the payment authentication information.

47. The medium of claim 46, further comprising:
paying the merchant, by the second trusted party component, on behalf of the customer.

48. The medium of claim 46, the method further comprising:
generating, by the first trusted component, an encryption of the confidential payment information and transaction information;
transmitting the encryption to the second trusted party component, who uses the encryption to verify the merchant signature and the payment authentication information.

49. The medium of claim 47, wherein transmitting the encryption to the second trusted party component is performed by saving the encryption in a database accessible to the first trusted party component and the second trusted party component.

50. A computer-readable medium containing instructions for causing a computer to perform a method for securing payment over a network from a customer to a merchant, the method comprising:
receiving an instruction from the customer to pay the merchant with a merchant signature;
obtaining confidential payment information of the customer;
verifying the merchant signature; and,
paying the merchant based on the confidential payment information, if the merchant signature is verified.

51. The medium of claim 50, the method further comprising:
generating payment authentication information based on the confidential payment information and transaction information; and
transmitting the payment authentication information with a third-party signature to the merchant.

52. The medium of claim 50, wherein paying the merchant comprises transferring funds from an account related to the customer to an account related to the merchant.

53. A apparatus for securing payment over a network from a customer to a merchant, the apparatus comprising:
a processing unit;
an input/output device coupled to the processing unit;
a storage device in communication with the processing unit, the storage device including,
program code for receiving an instruction from the customer to pay the merchant, the instruction including confidential payment information of the customer;
program code for generating payment authentication information based on the confidential payment information; and
program code for paying the merchant on behalf of the customer according to the payment authentication information, wherein the confidential payment information of the customer is not disclosed to the merchant.

54. The apparatus of claim 53, wherein the payment authentication information comprises a digital signature determined based on a secret key of the customer.

55. The apparatus of claim 53, the storage device further comprising:
stored confidential payment information.

56. A system comprising:
a trusted component capable of
receiving an instruction from a customer to pay a merchant;
obtaining confidential payment information associated with the customer,
generating payment authentication information based on the confidential payment information, and
transmitting the payment authentication information to a payment processor; and the payment processor capable of
verifying the payment authentication information and
paying the merchant on behalf of the customer according to the payment authentication information, wherein the confidential payment information of the customer is not disclosed to the merchant.

57. The system of claim 56, wherein the payment authentication information comprises a digital signature determined based on a secret key of the customer.

58. The system of claim 56, further comprising:
a shared database operatively connected to the trusted component and the payment processor, and wherein the verifying is performed based on a secret key of the customer stored in the shared database.

59. The system of claim 56, further comprising:
a payment component operatively connected to the trusted component and capable of preauthorizing the confidential payment information.

60. The system of claim 59, wherein the trusted component transmits the payment authentication information to the payment processor with a preauthorization from the payment component.

61. The system of claim 60, wherein the payment component is operatively connected to the trusted component and the transaction processor and the transaction processor is further capable of authorizing payment to the merchant based on a preauthorization from the payment component.
